(19) United States
(12) Patent Application Publication
(10) Pub. No.: US 2024/0009496 A1
(43) Pub. Date: Jan. 11, 2024

(54) NONOBSTRUCTIVE PROTECTIVE HOUSING FOR SPRINKLER HEAD

(71) Applicants: Mark Stephen Ouellette, York Harbor, ME (US); Carol Ann Leofanti, York Harbor, ME (US)

(72) Inventors: Mark Stephen Ouellette, York Harbor, ME (US); Carol Ann Leofanti, York Harbor, ME (US)

(21) Appl. No.: 18/473,679

(22) Filed: Sep. 25, 2023

Related U.S. Application Data
(63) Continuation-in-part of application No. 17/648,348, filed on Jan. 19, 2022.
(60) Provisional application No. 63/409,650, filed on Sep. 23, 2022.
(60) Provisional application No. 63/139,103, filed on Jan. 19, 2021.
(60) Provisional application No. 63/163,260, filed on Mar. 19, 2021.
(60) Provisional application No. 63/211,360, filed on Jun. 16, 2021.

(51) Int. Cl. A62C 31/28; B05B 15/14

(52) U.S. Cl. CPC A62C 31/28; B05B 15/14; A62C 31/02

(57) ABSTRACT

A nonobstructive protective housing for a fire sprinkler head has a first case half and a second case half with apertures formed in the case halves. The second case half is hingedly coupled to the first case half. The first case half and the second case half are movable between an open position and a closed position. A method of non-obstructively protecting a fire sprinkler head with the nonobstructive protective housing includes fastening the nonobstructive protective housing around the fire sprinkler head such that the apertures accommodate a flow of water from the fire sprinkler head.

### CROSS-REFERENCE TO RELATED APPLICATION

This application is a continuation-in-part of U.S. application Ser. No. 17/648,348, entitled SPRINKLER HEAD PROTECTIVE CASE DEVICE AND SYSTEM and filed Jan. 19, 2022, and claims the benefit of priority of U.S. provisional application No. 63/409,650, filed Sep. 23, 2022; U.S. provisional application No. 63/163,260, filed Mar. 19, 2021; and U.S. provisional application No. 63/211,360, filed Jun. 16, 2021. The contents of application Ser. Nos. 17/648,348, 63/409,650, 63/163,260, and 63/211,360 are herein incorporated by reference.

### BACKGROUND OF THE INVENTION

The present invention relates to sprinkler heads and, more particularly, to a protective case for fire sprinkler heads.

Accidental damage and/or activation of fire safety sprinkler heads can be caused by human error and/or construction related debris during active periods of construction, reconstruction, remodeling, renovation, demolition, and general maintenance. Temporarily shutting down, draining, and relocating sprinkler systems in areas designated for the foregoing activities results in excessive time and expense. Excessive time is spent contacting local fire departments at the time sprinkler systems are shut down and again when sprinkler systems are back in service. Moreover, an individual or individuals must provide constant supervision at the location where fire safety sprinkler systems are temporarily shut down, serving as a fire watch.

Currently available sprinkler head fire safety cages do not work well as they were designed to prevent large objects such as basketballs and volleyballs from contacting sprinkler heads. These sprinkler head cages do not offer adequate protection against small and medium construction debris (e.g., cement chips, steel fragments and other construction related flying debris) that can easily travel between cage bars and impact sprinkler heads. This is due in part to the amount of distance between cage bars. A worker's hand or tool can easily enter between the cage bars and contact sprinkler heads.

Painter cups are made of light thin plastic and only work to prevent paint from contacting sprinkler heads. Painter cups are very fragile and do not protect sprinkler heads from impact.

As can be seen, there is a need for a sprinkler head protection device that prevents small and medium construction debris, a worker's hand, or a tool from damaging a sprinkler head.

### SUMMARY OF THE INVENTION

In one aspect of the present invention, a nonobstructive protective housing for a fire sprinkler head comprises a first case half having apertures formed therein; and a second case half having apertures formed therein; wherein the second case half is hingedly coupled to the first case half, and wherein the first case half and the second case half are movable between an open position and a closed position.

In another aspect of the present invention, a method of non-obstructively protecting a fire sprinkler head comprises providing the nonobstructive protective housing; and fastening the nonobstructive protective housing around the fire sprinkler head such that the apertures accommodate a flow of water from the fire sprinkler head.

These and other features, aspects and advantages of the present invention will become better understood with reference to the following drawings, description, and claims.

### BRIEF DESCRIPTION OF THE DRAWINGS

FIG. 1 is a side perspective view of a fire sprinkler head protective case according to an embodiment of the present invention;

FIG. 2 is an exploded perspective view thereof, partly shown in cross-section;

FIG. 3 is an exploded cross-sectional view thereof;

FIG. 4 is an assembled perspective view thereof;

FIG. 5 is a detail perspective view of a latch thereof;

FIG. 6 is a perspective view of a fire sprinkler head protective case according to another embodiment of the present invention; and

FIG. 7 is a perspective view of a fire sprinkler head protective case according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a sprinkler head protective case that covers a fire safety sprinkler, providing superior physical protection during active periods of construction and maintenance without restricting water flow and distribution from the sprinkler head should a fire emergency occur while the case is attached.

The case may be left on sprinkler heads during the duration of active periods of construction and maintenance, eliminating the need to spend time and money temporarily shutting down, draining, and relocating fire sprinkler systems.

This eliminates spending excessive time contacting and informing local fire departments (1) prior to shutting down fire safety sprinkler systems and (2) when fire sprinkler systems are restored and operating. A fire watch is unnecessary so personnel providing constant supervision in areas where fire sprinkler systems are shut down is not needed.

The protective case, cases, or coverings may be applied to technological devices, machinery, engines, space exploration technology, domestic appliances, military equipment, and transportation. The protective cases or coverings may provide physical protection while at the same time enabling the protected article to function. For example, an outdoor automobile cover may also serve as a solar power charger for batteries.

The 3 most common pipe configurations in modern buildings for attachment to fire sprinkler heads are straight, elbow, and t-joint. The arms that attach and hold the inventive protective functional open cap in place can accommodate each of these.

In some embodiments, the protective case comprises snap latches. Snap latches enable the devices to be locked and secured once in place around sprinkler heads.

Male and female halves of the sprinkler head protective cases with snap latches may be injection molded plastic. The mold may be selected depending upon the embodiment.

In some embodiments, the protective case may be secured to the associated pipe configuration with a thumb screw clamp.

The device may have any suitable hinge(s). A first half of the device may have a male hinge pin. A second half of the device may have female hook hinges.

The geometrical shape of the presently disclosed device may be altered or reconfigured for a different physical appearance on the exterior as it enables adequate water distribution and protects a sprinkler head.

The exterior color of the device is not particularly limited and may be any existing color. For example, the device exterior may be high visibility yellow.

The protective device of the present subject matter may be used to protect any sprinkler heads in areas where active construction or maintenance will take place. The embodiment may be determined in accordance with the pipe configuration to which each sprinkler head is attached (straight, elbow, t-joint). First, a user may attach a female half of the protective case to the water supply pipe, aligning the case's clamping element to the exposed threaded section of the sprinkler head. Next, the user may attach a male half of device to the female half of the device by inserting a male hinge pin into a female hinge hook. Closing the device completely, the user may insert snap latches into snap latch receivers. To remove the device, the user may press down on the snap latches, separate the male half from the female half, and remove the device.

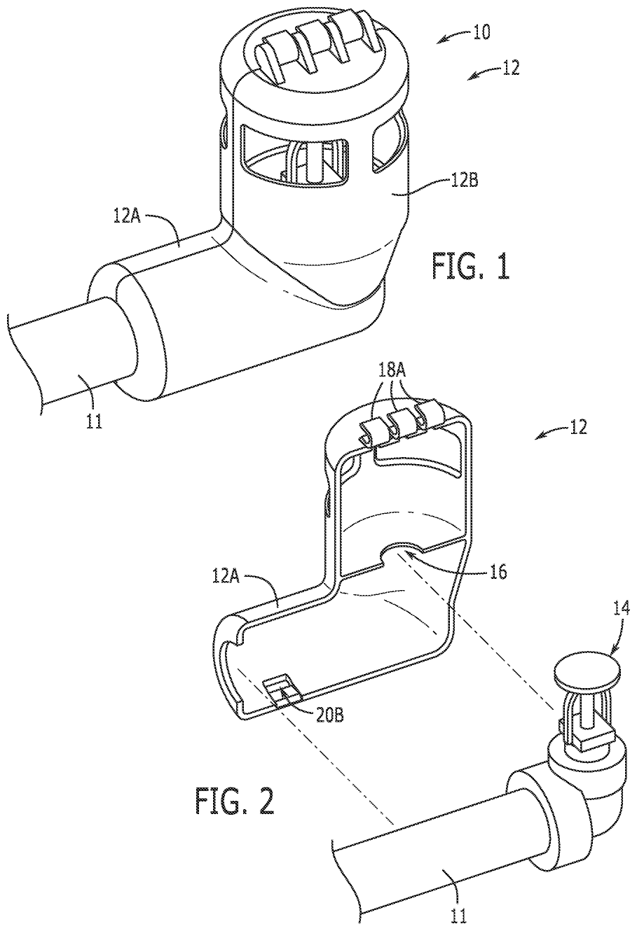

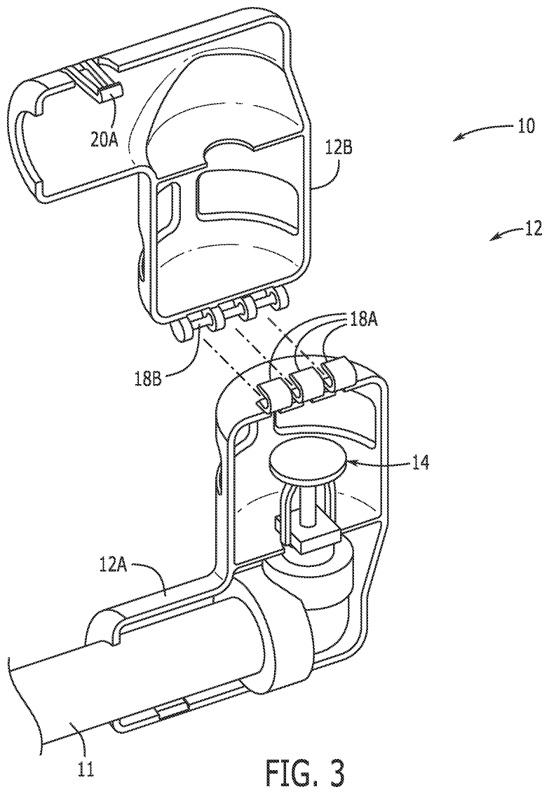

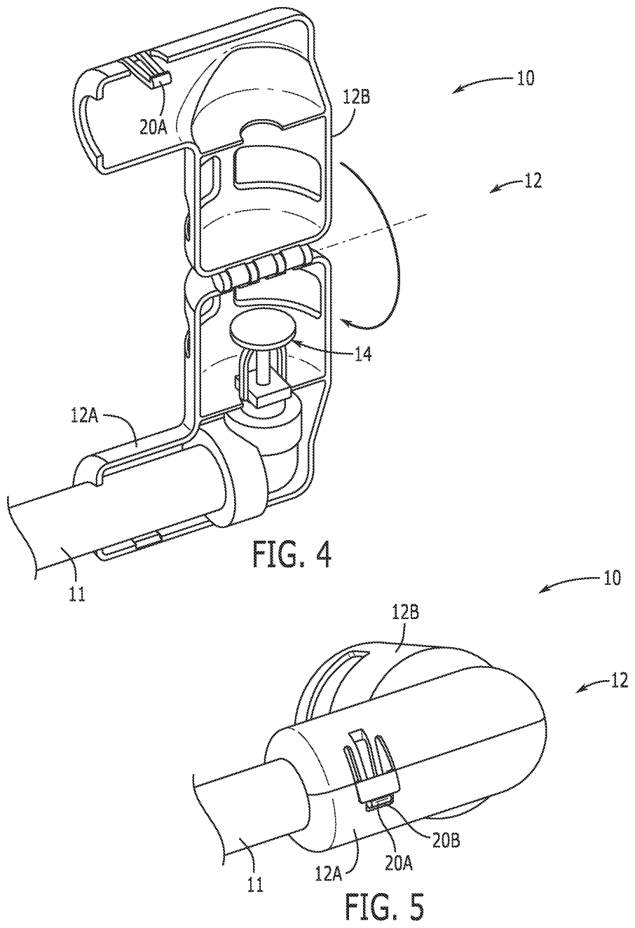

Referring to FIGS. 1 through 7, FIGS. 1-5 show a protective case 10, 12 according to an embodiment of the present invention for use on an elbow pipe configuration, including a first half 12A with hinge hooks 18A hingedly coupled with a second half 12B with a hinge pin 18B (see FIG. 3) mounted on a water supply line 11 and centered around a sprinkler spray head 14 by way of an alignment notch 16 (see FIG. 2). The case 10, 12 may be secured in place by engaging a snap latch 20A (see FIG. 3) in a snap latch receiver 20B (see FIG. 2). The case halves 12A, 12B each have apertures or fenestrations formed therein operative to allow water from the sprinkler head to pass such that the sprinkler head function in the event of a fire is not impeded. The fenestrations may have any suitable configuration. As shown, the fenestrations have a rounded rectangular perimeter and are spaced apart so that columns of the case material join a region above the fenestrations with a region below the fenestrations.

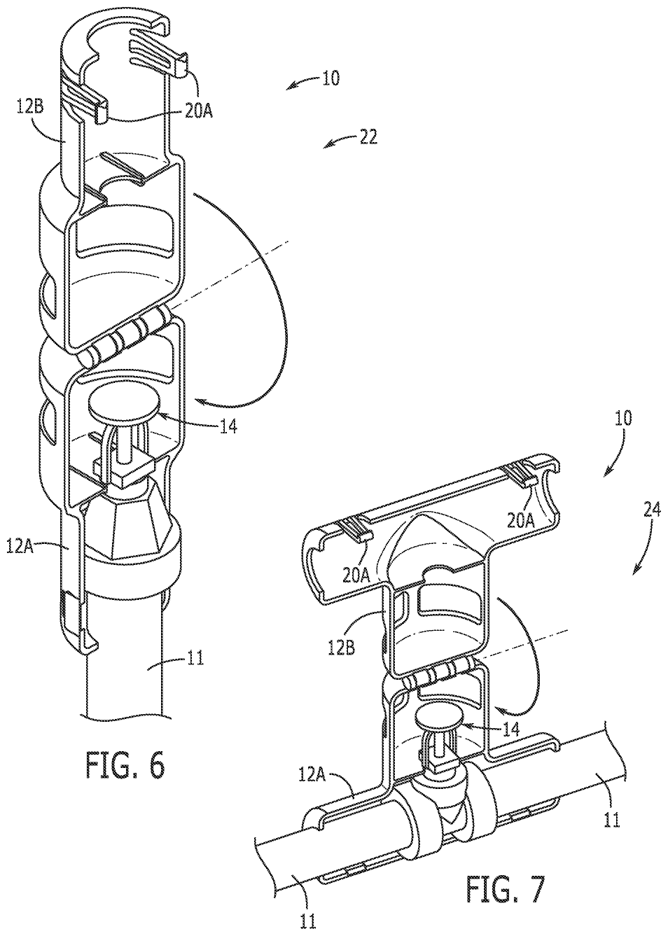

FIG. 6 shows a protective case 10, 22 according to an embodiment of the present invention for use on a straight pipe configuration.

FIG. 7 shows a protective case 10, 24 according to an embodiment of the present invention for use on a T-joint pipe configuration.

It should be understood, of course, that the foregoing relates to exemplary embodiments of the invention and that modifications may be made without departing from the spirit and scope of the invention as set forth in the following claims.

What is claimed is:

1. A nonobstructive protective housing for a fire sprinkler head, comprising:
a first case half having apertures formed therein; and
a second case half having apertures formed therein;
wherein the second case half is hingedly coupled to the first case half, and
wherein the first case half and the second case half are movable between an open position and a closed position.

2. The nonobstructive protective housing of claim 1, wherein the first case half comprises a first component of a latching mechanism and the second case half comprises a second component of the latching mechanism.

3. The nonobstructive protective housing of claim 1, wherein the first case half and the second case half each define a notch configured to accommodate a neck of the fire sprinkler head in the closed position.

4. The nonobstructive protective housing of claim 1, wherein the first case half and the second case half each define a flange operative to accommodate at least one pipe at a joint selected from the group consisting of an elbow joint, a straight section, and a T-joint.

5. The nonobstructive protective housing of claim 4, wherein at least one of the first case half and the second case half fasten to the at least one pipe.

6. A method of non-obstructively protecting a fire sprinkler head, comprising:
providing the nonobstructive protective housing of claim 1; and
fastening the nonobstructive protective housing around the fire sprinkler head such that the apertures accommodate a flow of water from the fire sprinkler head.
